(19) United States
(12) Patent Application Publication
(10) Pub. No.: US 2016/0245015 A1
(43) Pub. Date: Aug. 25, 2016

(54) Door Hinge Gap Blocker for the Protection of Hands and Fingers

(71) Applicant: Raymond E. Davis, Dallas, TX (US)

(72) Inventor: Raymond E. Davis, Dallas, TX (US)

(21) Appl. No.: 14/628,242

(22) Filed: Feb. 21, 2015

(51) Int. Cl. E06B 7/36

(52) U.S. Cl. CPC E06B 7/367; E06B 7/36

(57) ABSTRACT

A hinge stile gap blocking apparatus and a method designed to prevent hand and finger injuries resulting from inadvertent door closures. The apparatus includes a hinge gap cover for use with an existing hinged door and door surround configured to continuously occlude the hinge stile gap between a door jamb and the outer facing edge of a door hinge stile. The hinge stile gap blocking apparatus has a curved portion that is shaped to track the arc of an inner edge of the door hinge stile when the door is pivoted from an open to closed position and from the closed to the open position. The apparatus is sufficiently rigid so that fingers cannot pry around the curved portion and thus risk exposure to the hinge stile gap of the door. When the door is pivoted on the hinges of the door, the inner edge of the door hinge stile traces a curved path and follows the curved portion so that the hinge stile gap is occluded at all times.

### FIELD OF THE INVENTION

This invention relates to the field of injury prevention devices and more particularly, devices and methods to insure the safe operation of doors.

### BACKGROUND OF THE INVENTION

The open area of a door hinge frequently attracts the eyes and exploring fingers of small children and accounts for 55% of door related injuries. If the door closes while fingers are within this area, as much as 40 tons of pressure per square inch is created easily crushing or pulverizing human tissue, and amputating fingers.

It has been reported that according to the National Safety Council—Injury Facts 2011 Edition; U.S. Consumer Product Safety Commission's National Electronic Injury Surveillance System, that approximately 380,800 door related injuries occur in the United States every year. Door related injuries occur at a rate of 31,000 month, 1,000 every day, 42 every hour and 1 every 1.4 minutes. According to one study; Clinical Pediatric Study: “Children Treated in the United States Emergency Departments for Door-related Injuries, 1999-2008”, approximately eighty percent of door-related injuries occur to children in the home and approximately forty two percent of these children were under the age of four. Thousands of children every year are sent to the hospital with fractures, crushed and pulverized tissue or broken bones because portions of fingers and hands were caught in slamming doors.

Door injuries are very serious, disastrous, and potentially life changing. Amputations are a triple threat involving loss of function, loss of sensation, and loss of body image causing postoperative complications such as psychological problems, phantom pain, adverse emotional health, and needed psychosocial support. Individuals who earn their living from motor skills are especially vulnerable to amputations. Amputation in the preadolescent or adolescent age group is a great threat to emerging self image and sexual identity, and elderly amputees are at a greater risk for psychiatric disturbances such as depression, social isolation, new financial stringencies, and occupational limitations which complicate the adjustment to serious door hand injuries or finger amputations.

The true incidence of door-related injuries is underestimated because not all door related injuries are treated in hospital Emergency Departments and urgent care centers do not report statistics. Of the reported cases, tens of thousands of door related injuries result in finger amputations to children. Even one door injury is too many. Embodiments of the present invention can prevent most if not all of this type of injury.

The present invention will not only prevent injury to children by unintended door closings, but will mitigate real potential legal and financial liability to many public and private facilities. There are many potential legal theories under which these public and private facilities having known and foreseeably unsafe doors can be found legally liable for these injuries including: attractive nuisance doctrine, premises liability, landowner-occupier duties, general negligence, products liability, and strict liability for health and safety code or building violations. For example, under the attractive nuisance doctrine, where the trespass of a child is likely, a landowner owes a duty to exercise ordinary care to avoid a foreseeable risk of harm posed by known dangerous artificial conditions, which result from the child's inability to appreciate the risk of harm. Many heavy commercial doors in commercial buildings readily attract children. Some of these doors and door surrounds have attractive shiny metallic finishes or bright colored paint baiting the eyes and fingers of child. Doors are easily accessible to the exploring fingers of young children who are unable to appreciate the dangerous condition.

Liability under the attractive nuisance doctrine can be imposed as there now exists the inventor's known door hinge safety device which can be installed at a small cost compared to the overall door installation. Thus, the cost of eliminating the known dangerous artificial condition of the finger amputating door is not so burdensome and this duty to install should be afforded even with respect to child trespassers.

Landowner or occupier liabilities can be found significantly more easily than under the attractive nuisance doctrine since landowners or occupier liability extends to licensees and/or invitees when they are injured in the face of known and foreseeable risks posed to them.

The Health and Safety Act from England is a piece of legislation enacted by the UK legislature codifying health and safety regulations in the work place. It essentially spells out and mandates the “duty of care” employers have over the health, safety, and welfare of their staff in the workplace. Codified law imposes strict liability which eliminates the generally required “mens rea” or mental/intentional/intent element of a crime, ordinances, code, or statute.

Summarizing the codified law of the Health and Safety Act, the law asserts that an employer is required to manage the health and safety of the work place as to prevent accidents and ill-health. In complying with the law the employers/landowners are required to identify and avoid physical hazards, carry out risk assessments, and even prepare written safety statements. These physical hazards of the codified Health and Safety Act would extend to having a duty of care to prevent finger-trapping accidents in doors and gates. Risks posed by all doors and gates must be assessed and reasonable precautions taken to ensure that the doors can be safely used. Since finger and hand guarding devices are readily available, easy and inexpensive to install, not doing so would most likely would be a breach of the duty of care imposed by the Health and Safety Act and similar codified law that is likely to be more and more prevalent throughout the United States.

A nursery in the suburb of Norwich in the English county of Norfolk was fined £75,000 for the nursery's breach of its imposed “duty of care” under the Health and Safety Act for not installing door finger guards. The injury sustained in that nursery in which a 14-month old had his finger amputated from a door closing was of the same type of injury that the Health and Safety Code was designed to prevent and thus liability was found.

Throughout the United States there is an abundance of well settled case law upholding strict liability for crimes in which apartment owners, landlords, and occupiers has violated health, building, public safety, and fire prevention code, ordinances, statutes, and regulations.

In the case of People v. Bachrach (1980) 114 Cal. 3d Supp. 8, 170 Cal. Rptr. 773 the owner of an apartment building who was being prosecuted for violation of a number of provisions in an ordinance relating to public safety and fire prevention, the court rejected the defendant's proposed jury instruction which provided that “there must be a joint operation of act or conduct and criminal intent.” The court found that the crimes which the apartment owner was charged with did not require proof of guilty knowledge or intent. It held that the doctrine of strict liability applied and therefore neither intent nor criminal negligence was an essential element of the crimes charged.

The Court in the case of the People v. Balmer (1961) 196 Cal. App. 2d Supp. 874 dealt with statutes and offenses of a regulatory nature that were found to be enforceable irrespective of criminal intent or criminal negligence. In this case the defendants were being convicted for owning and operating a nursing and convalescent home without keeping it in good repair and in a neat and sanitary condition at all times. The court held that neither guilty knowledge nor intent had to be shown and that the mere omission to fulfill the required standard constituted the crime charged.

As more codified law, codes, statutes, and regulations are promulgated throughout the various states, cities and municipalities within the United States, we will see more criminal liability imposed, fines, and penalties for breaches in violations of failure to take precautions to ensure door safety.

Thus, the benefits of the invention surpass the mitigation of hand and finger injuries by extending to mitigate real financial and legal liabilities.

Description of Prior Art

Major problems facing current users of door safety closure prevention devices is that many such devices require modifications to door or door frame construction. Moreover, such devices do not fully and effectively occlude a door hinge gap when the door is transitioned from an open position to a closed position and from a closed position to an open position sufficient to prevent hands and fingers from being crushed, injured, or amputated. Further, many door safety closure prevention devices are just movable stops that many times get displaced from their original intended position and fail to prevent a door from closing.

For at least the foregoing reasons, there is a need for a door safety closure device that will prevent hands and fingers from being crushed, injured, or amputated within the hinge area of the door and door surround. Moreover, the invention will prevent the economic loss of serious door injuries resulting from loss of livelihood, increased government disability payments, and diminished functional capacity of the amputees. Further, the invention will mitigate financial and legal liability that is created under legal causes of action filed under premise liability, landowner-occupier liability, general negligence, attractive nuisance doctrine, or products liability law suits.

### SUMMARY

The present invention is directed to a hand and finger door protector for residential and commercial doors that will protect hands and fingers from being crushed, injured, or amputated in a hinge gap of the door and door surround by the unintended slamming or closing of the door. Embodiments of this invention are designed to be used with any type of pivoting door and occlude the hinge gap of the door at all times and at all door positions.

The apparatus and method disclosed herein prevents injury to body parts resulting from door closure. The apparatus and method described herein achieve injury prevention by the steps of providing a door frame and a door wherein portions of the door frame are installed with a specially shaped apparatus having portions that occlude the hinge gap of a door when opening or closing the door. More specifically, the hinge gap blocking apparatus has a curved or vaulted portion that is shaped to match the arc of an inner edge of a door hinge stile when the door is pivoted from an open to closed position and from a closed to an open position. The apparatus is sufficiently rigid so that fingers cannot pry around the vaulted portion and thus risk exposure to the hinge gap of the door.

The hinge gap blocker is typically attached to an inside facing surface of a door frame, and comprises a plate for affixing to the door frame and a vaulted portion that once the apparatus is installed, resides outside the door frame, adjacent to the inner edge of the door hinge stile. When the door is pivoted on its hinges, the inner edge of the door hinge stile slidably tracks the periphery of the vaulted portion so that the hinge stile gap is occluded at all times.

Factors and Aspects of the Invention

First, the inventor is not aware of existing hand and finger door safety devices that occlude the hinge stile gap of a door in the manner of the present invention.

Second, embodiments of this invention include fastening means for attaching the hinge gap blocker to a door jamb that include one or more mounting portions, portions of which may be aligned with portions of the door jamb and which may be affixed to the inside of a door frame using nails, threaded fasteners, brush on adhesives, adhesives with a peel away backing, or other such fastening means as will be appreciated by those skilled in the art, facilitating quick installation. The mounting portion may comprise a substantially flat plate with apertures for insertion of threaded fasteners, a layer of adhesive exposed by a peel away backing. The mounting portion may include a metal plate that includes piercing tabs or points that, in the case of wooden door jambs may be driven into the door jamb.

Third, embodiments of the apparatus may possess one or more sections for spanning the distance of an inner door frame between hinges.

Fourth, embodiments of the present invention may include a means to produce multiple sections; e.g., by severing, sawing or separating smaller sections from a larger section wherein the smaller sections are custom fitted to span the distance of an inner door frame between hinges, or, include pre-sized section(s) that bridge a hinge to provide a continuous outwardly facing section of a hinge stile gap blocker.

For at least the foregoing reasons, there is a need for apparatus and method designed to prevent door closure injuries resulting from placement of fingers and hands into the hinge stile gap of open doors. Embodiments of the invention, the details and features of which are shown in the drawing figures and detailed description that follow will reduce the risk of hand and finger injuries and amputations, lessen the economic loss of serious door injuries due to loss of livelihood, lessen government disability payments, prevent amputation and the sequelae of diminished functional capacity of the amputees and reduce the risk of legal causes of action against premises having foreseeably dangerous doors.

The foregoing and other objects, features, and advantages of the invention will become more apparent from the following detailed description, which proceeds with reference to the accompanying figures wherein the scale depicted is approximate.

### BRIEF DESCRIPTION OF THE DRAWING FIGURES

FIG. 1 is a top plan view of a partial section of one embodiment according to the present invention;

FIG. 2 is a back plan view thereof;

FIG. 3 is an end view thereof taken from the direction indicated by arrow (a);

FIG. 4 is a perspective view thereof;

FIG. 5a is a perspective view of a side opposite that shown in (FIG. 4);

FIG. 5b is an exemplary plug for fitting in an end of sections of a hand and finger protector;

FIG. 5c is a exemplary connector for connecting the ends of sections of a hand and finger protector;

FIG. 6 is a perspective view depicting one exemplary installation according to an embodiment of the invention;

FIG. 7 is a perspective view depicting one exemplary installation according to an embodiment of the invention;

FIG. 8 is a perspective view depicting one exemplary installation according to an embodiment of the invention.

### REFERENCE LISTING OF THE NUMBERED ELEMENTS

100 door
120 door leading edge
130 door surround
140 door frame
142 door jamb
144 door jamb stop
146 door casing
150 inner edge hinge stile
160 outer edge hinge stile
180 hinge stile gap
190 door hinge
200 hinge stile gap blocker
210 plate
212 adhesive
213 backing
214 fastener aperture
220 vaulted portion
221 space
230 plug
240 connector

Definitions

In the following description, the term “door” as used herein, includes pivoting or hinging panels that are designed to occlude a doorway. The term “complete door closure” as used herein, means the edge of the door is substantially flush with a door surround and wherein there is minimal gap between the edges of the door and the frame. The term “door surround” as used herein, means the structure surrounding a door, whether outward facing or inward facing, and includes raised molding (casing), or other non-raised surface, e.g., wall or cabinetry surfaces directly adjacent to—or abutting the door's edge(s). The term “door jamb” as used herein, refers to portions of the door frame that are typically at a right angle relative to the casing of the door when the door is shut. The term “leading edge” also known as the “shutting stile,” refers to that portion of a door that leads when the door is being moved from an open to closed position; e.g., the lock stile of a rail and stile door. The term “hinge stile” refers to the vertical portion of a door edge to which hinges are affixed and about which the door pivots. The term “hinge stile gap” refers to the gap created between the back edges of a door and a door frame when the door is partially or wholly opened. As used herein, “fasteners” means any customary means to fasten one object to another, including threaded fasteners, non-threaded fasteners, staples, tape, adhesives, welding, or other means as will be appreciated by those having skill in the art and benefit of this disclosure whether for permanent or semi-permanent use. Unless otherwise explained, any technical terms used herein have the same meaning as commonly understood by one of ordinary skill in the art to which this disclosure belongs. The singular terms “a”, “an”, and “the” include plural referents unless the context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” All publications, patent applications, patents, and other references mentioned herein are incorporated by reference in their entirety for all purposes. In case of conflict, the present specification, including explanations of terms, will control. In addition, the materials, methods, and examples are illustrative only and not intended to be limiting.

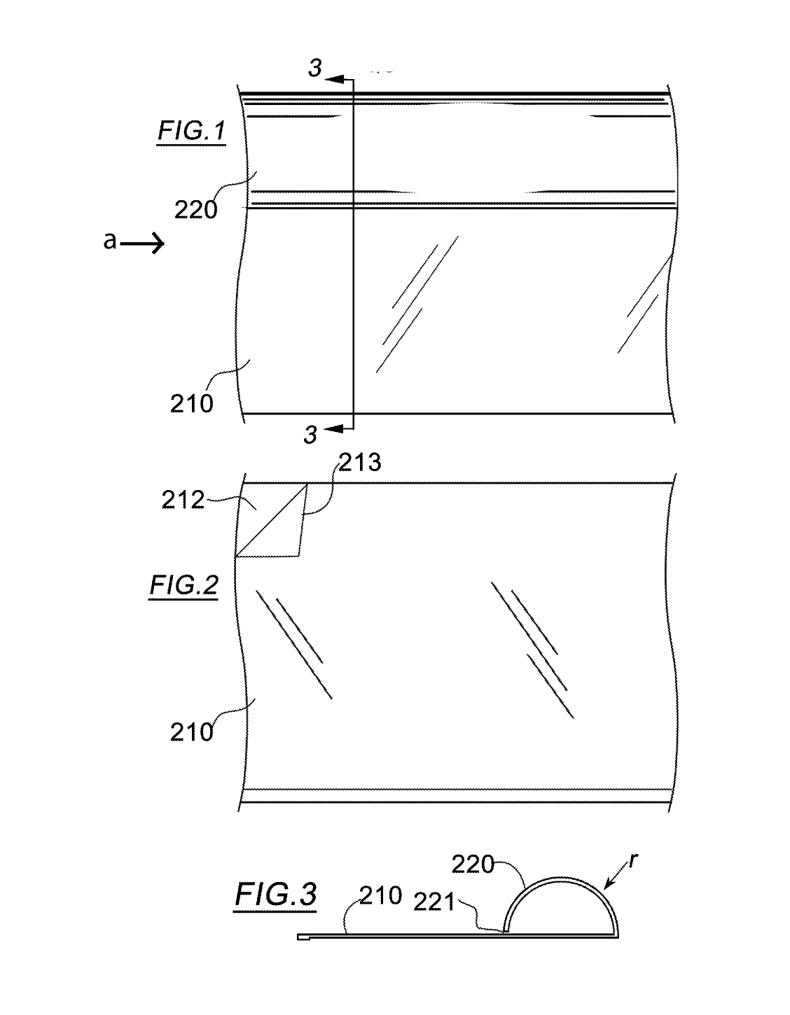

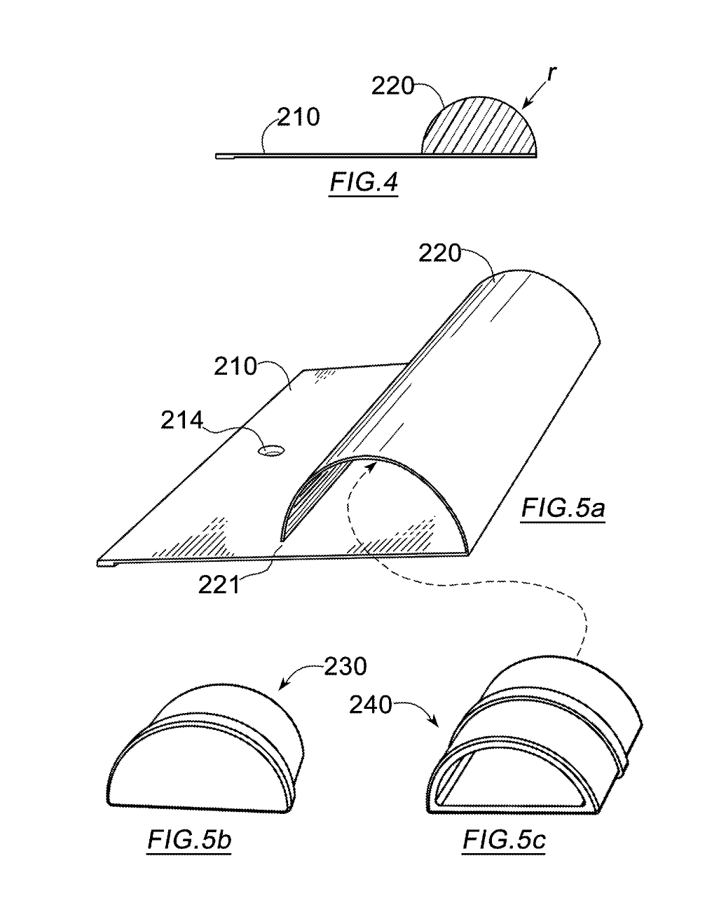

Referring generally to FIGS. 1-8, embodiments according to the present invention for a hand and finger protector and a method for preventing injuries resulting from insertion of hands and fingers into a hinge stile gap 180 of a door 100 include, a door hinge stile gap blocker 200 having an mounting portion; typically a plate 210 for affixment and alignment to portions of a door, and a curved portion that is typically vaulted 220, and can be a solid construction (FIG. 4), possessing a curvilinear profile that matches the travel path of an inner edge 150 of a door hinge stile when the door is pivoted, such that the inner edge of the hinge stile slidably abuts following the profile of the curved portion or passes very closely to the curved portion when being opened or closed, and whereby once installed, the hinge stile gap 180 is occluded by the hinge stile gap blocker irrespective of door position. While in the embodiments depicted herein, the curved portion is an extension of the plate, it is possible that the curved portion may be a separate element that is joined to, or paired with the plate prior to installation. The curved portion may have any radius appropriate for any pivoting door. Typically, the apparatus is a multi-part assembly wherein sections are aligned with the stop 144 of a door jamb 142 in spaces between hinges 190. Sections of the apparatus may be fastened to the door jamb by any means that will be appreciated by those skilled in the art, including threaded fasteners, nails or adhesives. For example, in some cases, a light tack adhesive on the plate 212 exposed by a peel-away backing 213 can be used to position and reposition sections of the hinge stile gap blocker so that the inner edge of the hinge stile tracks the arc of the curved portion closely, and once positioned, the sections may be fastened more securely to the door jamb, with threaded fasteners or other means that will be appreciated by those having skill in the art. While one preferred material for the hinge blocker is stamped and formed steel, rigid or semi-rigid plastics, or a combination of materials may also be used. The hinge stile gap blocker may be provided in multiple sections of pre-determined length, or, one or more sections may be cut to length by an installer in order that the sections are sized to span the distance between hinges. In cases where the hand and finger protector is formed steel, a connector 240 (FIG. 5c) may join multiple sections, and a plug 230 (FIG. 5b) may be used to cap exposed ends.

Embodiments of the hinge stile gap blocking apparatus may be retrofitted to an existing door and door jamb, or, may be pre-installed on pre-hung doors. Alternately, the apparatus may be provided in a kit form suitable for home or commercial use. It is even conceivable that the hinge stile blocking apparatus be incorporated into wood, plastic or metal commercial door frames at the time of manufacture.

FIGS. 1 and 2 show respectively, a top plan view and bottom plan view of a section of one embodiment according to the present invention. FIG. 3 is an end view of (FIG. 1) showing a plate portion 210 and a vaulted portion 220. In the particular embodiment depicted in FIGS. 1-3 and 5a, a gap or space 221 between an edge of the vaulted portion and the plate permits the vaulted portion which is preferably constructed of a resilient material, to flex slightly in order to accommodate surface irregularities that may be found on the inner edge of the hinge stile that slidably abuts vaulted portion of the apparatus once installed.

In a perspective view FIG. 5a best shows a space 221 between one end of the curved section 220 and plate 210. In cases where the material is resilient, the space provides some flexibility for the curved portion when the inner edge 150 of the hinge stile rubs against it. FIGS. 5b and 5c depict respectively, a cap or plug 230 for sealing the ends of sections, and a connector 240 for joining multiple sections.

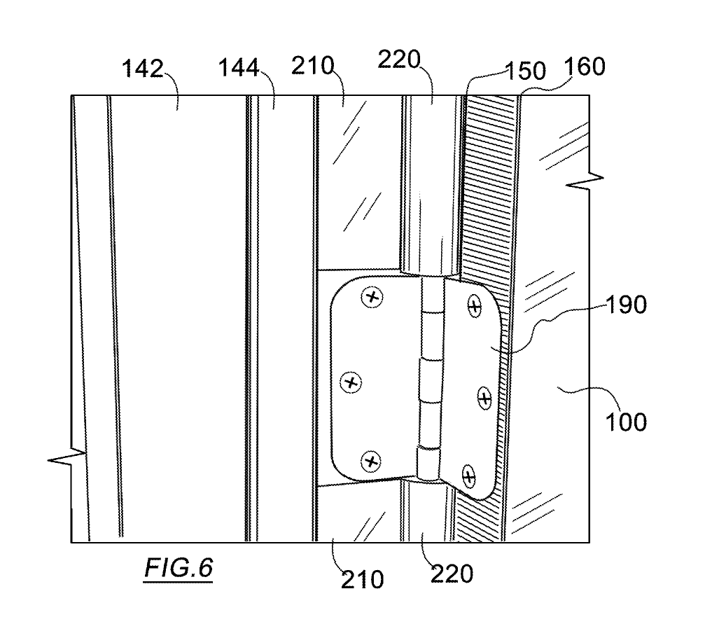

FIG. 6 in a perspective view of the nexus of a door jamb and a hinge stile of a door, shows a multi-section embodiment installed to the door jamb between hinges 310, and intruding into the hinge stile gap between the jamb and door. Inner edge 150 of the door hinge stile slidably abuts curved portion 220 when the door is pivoted.

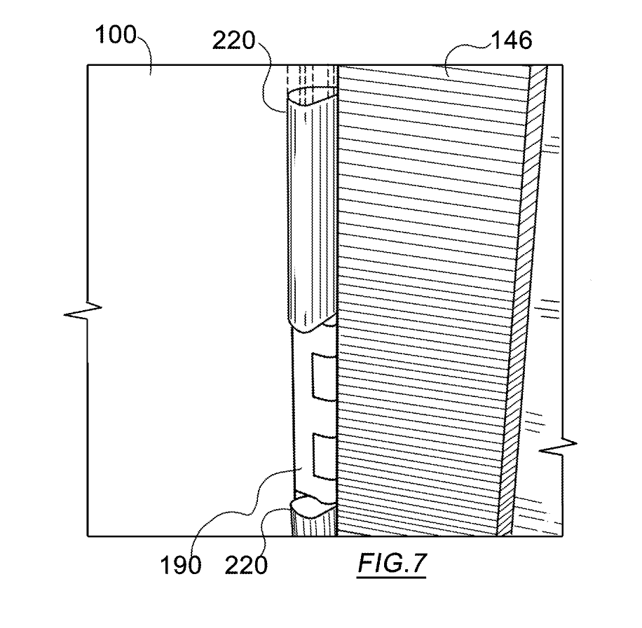

FIG. 7 is a view taken from the opposite side of the door shown in (FIG. 6), and shows the relationship of the door and door casing 146 and how curved portions 220 of the hinge stile gap blocker 200 extend into the hinge stile gap 180 between and beyond the door and the the casing.

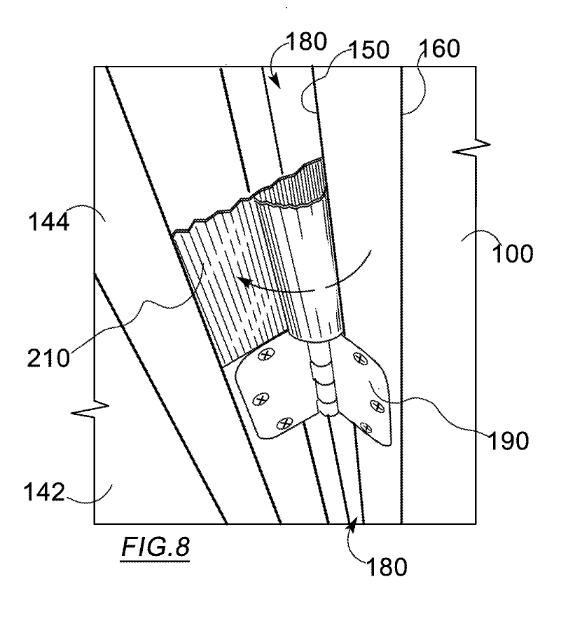

FIG. 8 depicts for conciseness and clarity, a partial section of a hinge stile gap blocker 200 affixed to the door jamb 142 above a hinge and with the plate portion 210 aligned with jamb stop 144.

The following is one exemplary method of installation according to embodiments of the invention:

(1) providing at least one section of a hinge stile gap blocker, wherein the at least one section has an mounting portion and, paired with or joined to the mounting portion, a curved portion;
(2) measuring the distance between hinges on a door jamb;
(3) sectioning the hinge stile gap blocker to match the measured distance(s);
(4) aligning edges of the mounting portion to portions of the door jamb so that the hinge stile gap is occluded for all door positions; and,
(5) fastening the gap blocker to the door jamb.

The following is another exemplary method of installation according to embodiments of the invention:

(1) providing a hinge stile gap blocker having an mounting portion, and, paired with or joined to the mounting portion, a curved portion longitudinal the mounting portion;
(2) measuring the distance between hinges on a door jamb;
(3) selecting sections of the hinge stile gap blocker to fit between hinges mounted to a door jamb;
(4) aligning sides of the mounting portion to portions of the door jamb so that the hinge stile gap is occluded for all door positions; and,
(5) fastening the gap blocker to the door jamb.

The following is yet another exemplary method of installation according to embodiments of the invention:

(1) providing a hinge stile gap blocker and a door jamb of a door frame wherein the hinge stile gap blocker is fitted to or incorporated with the door jamb at the time of door jamb manufacture;
(2) fitting hinges to spaces between sections of the hinge stile gap blocker;
(3) aligning and hanging a door to the door frame so that the hinge stile gap is occluded for all door positions.

It should be understood that the drawings and detailed description herein are to be regarded in an illustrative rather than a restrictive manner, and are not intended to be limiting to the particular forms and examples disclosed. Accordingly, it is intended that this disclosure encompass any further modifications, changes, rearrangements, substitutions, alternatives, design choices, and embodiments as would be appreciated by those of ordinary skill in the art having benefit of this disclosure, and falling within the scope of the following claims.

1. A door safety apparatus for protecting hands and fingers comprising:
at least one hinge stile gap blocker member configured to fit to a door jamb between the door jamb and a hinged door and continuously occlude a gap created between the door jamb and an inner edge of a door hinge stile of the door when the door is transitioned from an opened state to a closed state or from a closed state to an opened state, and wherein the at least one hinge stile gap blocker further comprises:
a first end having a raised curved portion configured for slidable contact with the inner edge of the door hinge stile when the door is pivoted;
a second end opposite the first end with a mounting portion extending from the raised curved portion which includes:
a plate with a substantially planar top surface, a terminal edge adapted to align to a jamb stop of the door jamb, a mounting surface opposite the top surface adapted to mount to a surface of the door jamb to which door hinging plates are mounted, wherein the plate is sufficiently thin to reside between the door jamb and the door hinge stile without interfering with complete closure of the door, and, wherein the second end is hidden on both sides of a doorway, and the first end is visible on only one side of the doorway; and,
at least one fastener for attaching the at least one hinge stile blocker member to the door jamb.

2. The at least one hinge stile gap blocker member according to claim 1 having ends that are configured to align with an adjacent at least one hinge stile pap blocker member when the at least one hinge stile gap blocker members are placed in the door jamb.

3. The at least one hinge stile gap blocker member according to claim 1 wherein the mounting portion extends from the curved portion and is configured for attachment to the door jamb.

4. The apparatus according to claim 1 wherein the at least one hinge stile gap blocker member is comprised of separable elements.

5. The at least one hinge stile gap blocker member according to claim 1 further comprising an alignment portion for alignment to an edge of a door.

6. The at least one hinge stile gap blocker member according to claim 1 further wherein the curved portion has a semicircle shape.

7. The apparatus according to claim 1 wherein the raised curved portion includes a vaulted portion.

8. A method of providing a safe door comprising the steps of:
(1) providing at least one hinge stile gap blocker member having first end including: a mounting portion possessing a substantially flat top surface sufficiently thin to reside between the door jamb and the door hinge stile without interfering with complete closure of the door, a substantially flat bottom surface, a terminal edge for alignment to a portion of a door jamb, and, a second end including: a curved portion extending from the otherwise flat top surface configured to continuously occlude a door hinge stile gap when wherein the curved portion of the blocker member is configured to abut portions of a rear door edge when the door is transitioned from an open position to a closed position and from the closed position to the open position; and,
(2) attaching the mounting portion of the at least one hinge stile gap blocker member to a door jamb by aligning the terminal edge to a jamb stop of the door jamb, mounting the substantially flat bottom surface to a surface of the door jamb to which door hinging plates are mounted, and wherein the first end of the hinge stile gap blocker member is hidden on both sides of a doorway, and the second end of the hinge stile gap blocker member is visible on only one side of the doorway.

9. The method according to claim 8 further comprising at least one hinge stile gap blocker member configured to abut another at least one hinge stile blocker member and align with an edge of a door when installing.

10. The apparatus according to claim 8 further comprising aligning portions of the at least one hinge stile gap blocker member to the door jamb.

11. The apparatus according to claim 8 further comprising a connector for end to end joining of the at least one hinge stile gap blocker member to an adjacent at least one hinge stile gap blocker member.
